(19) United States
(12) Patent Application Publication
(10) Pub. No.: US 2008/0165339 A1
(43) Pub. Date: Jul. 10, 2008

(54) Spatial energy distribution by slit filter for step-and-scan system on multiple focus exposure

(75) Inventor: Jung Sunwook, Hsinchu (TW)

Correspondence Address: Akin Gump LLP - Silicon Valley, 3000 El Camino Real, Two Palo Alto Square, Suite 400, Palo Alto, CA, 94306, US

(73) Assignee: Macronix International Co., Ltd.

(21) Appl. No.: 11/649,570

(22) Filed: Jan. 4, 2007

(51) Int. Cl. G03B 27/72; G03B 27/52

(52) U.S. Cl. 355/71; 355/77

(57) ABSTRACT

A radiation source directs radiation along a radiation path. An exposure slit positioned along the radiation path directs the radiation at the substrate. The exposure slit has center and edge portions. A lens positioned along the radiation path has an optimal focus position. A support stage supports and moves the substrate relative to the radiation path along a substrate path. The support stage is inclined at a stage angle relative to the radiation path, such that radiation passing through the center portion of the exposure slit contacts the substrate at the optimal focus position of the lens. A filter is positioned along the radiation path and adjacent the exposure slit. The filter transmits more of the radiation at the center portion of the exposure slit relative to radiation transmitted at the edge portions of the exposure slit. A method is also described.

### BACKGROUND OF THE INVENTION

The present invention relates to photolithography, and more particularly, to a step-and-scan photolithography method for manufacturing semiconductor wafers.

Photolithography is a process used in semiconductor manufacture for transferring a pattern from a reticle (or mask) onto a substrate. The substrate is coated with a light-sensitive photoresist material. When exposed to light, the material hardens and is left behind after the remainder is cleared away, thereby forming a pattern. The pattern is used to etch or otherwise make modifications to the semiconductor wafer.

The reticle contains the desired pattern. Light is directed toward and passes through the reticle. The light then enters a lens for projection onto the substrate. Typically, the lens projects the pattern in a 1:1 ratio, or it may reduce the image size as necessary for manufacturing smaller scale wafers. As with any lens assembly, it is important to ensure the pattern is in the best possible focus to enable accurate manufacture.

There are two major systems for performing photolithography: stepping and scanning. Stepping involves exposing one area of the wafer at a time. The process continues until all necessary areas of the wafer have been exposed. Scanning uses an exposure slit to project the light while the reticle and substrate are both moved relative to the slit. The reticle is often moved in a direction generally opposite to the direction of the movement of the substrate. The speed at which the reticle and substrate move is determined by the width of the slit, the intensity of the light, and whether the image is 1:1 or scaled down. A step-and-scan system combines the two techniques.

The depth of field (DOF) is the range of focus that keeps the printed pattern within specifications. Initially, the DOF for these systems was limited. Multiple imaging was thus introduced. Multiple imaging involves exposing the reticle at multiple focus offsets. Two or more exposure periods were required to complete the transfer, increasing the throughput time. This was solved by tilting the wafer as shown in FIG. 1B. Rather than exposing a horizontally oriented wafer multiple times (FIG. 1A), the wafer is tilted and scanned over a focus range, allowing for multiple focus plane imaging with just one exposure.

Despite the increase in the DOF, multiple imaging introduced a problem of contrast degradation. Exposure latitude, the amount by which one can overexpose or underexpose the resist film and still have acceptable results within the specifications, was lost as a result. It is therefore desirable to use a photolithography system which increases the DOF but maintains an acceptable exposure latitude.

### BRIEF SUMMARY OF THE INVENTION

A preferred embodiment of the present invention includes an apparatus for transferring a pattern to a substrate. The apparatus includes a radiation source directing radiation along a radiation path. The apparatus further includes an exposure slit positioned along the radiation path for directing the radiation at the substrate. The exposure slit has a center portion and edge portions. A lens positioned along the radiation path has an optimal focus position. The apparatus also includes a support stage for supporting and moving the substrate relative to the radiation path along a substrate path. The support stage is inclined at a stage angle relative to the radiation path, such that radiation passing through the center portion of the exposure slit contacts the substrate at the optimal focus position of the lens. The apparatus also includes a filter positioned along the radiation path and adjacent the exposure slit. The filter is configured to transmit more of the radiation at the center portion of the exposure slit relative to radiation transmitted at the edge portions of the exposure slit.

A further embodiment of the present invention includes a method of transferring a pattern to a substrate. The method uses radiation directed along a radiation path. The radiation passes through an exposure slit having a center portion and edge portions. The radiation further passes through a lens having an optimal focus position. The method includes orienting the substrate at a non-normal angle relative to the radiation path; moving the substrate relative to the radiation path along a substrate path such that the radiation passing through the center portion of the exposure slit contacts the substrate at the optimal focus position of the lens; and distributing the radiation such that more of the radiation is transmitted from the center portion of the exposure slit relative to the radiation transmitted from the edge portions of the exposure slit.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

FIG. 1A is a prior art assembly for scanning a pattern from a reticle onto a wafer;

FIG. 1B is a prior art assembly for scanning a pattern from a reticle onto a wafer, where the wafer is tilted for multiple imaging;

FIG. 2 shows the effect of a filter, in accordance with preferred embodiments of the present invention, on transmittance of the radiation from the slit;

FIG. 3 shows intensity of transmitted radiation corresponding to different imaging planes in accordance with preferred embodiments of the present invention;

FIG. 4 is an illustrative example for determining the focus range of a photolithography assembly;

FIG. 5 shows the slit intensity formation on the wafer in accordance with preferred embodiments of the present invention;

FIG. 6 shows plots of Contrast Value and Contrast Degradation for a single image scan at various Defocus positions;

FIG. 7 shows a plot of Contrast Value vs. Defocus for a double image scan, an illustration of D_{flex} for a double image scan, and a plot of Contrast vs. Average Focus Position for a double image scan;

FIG. 8 shows a plot of Contrast Value vs. Defocus for a triple image scan and an illustration of D_{flex} for a triple image scan;

FIG. 9 is a chart comparing various parameters for single, double, and triple image scans with even energy distribution and a triple image scan with varied energy distribution; and

FIG. 10 shows a plot of Contrast against Average Focus Position and a plot of Exposure Latitude against DOF for the four scan types described in FIG. 9.

### DETAILED DESCRIPTION OF THE INVENTION

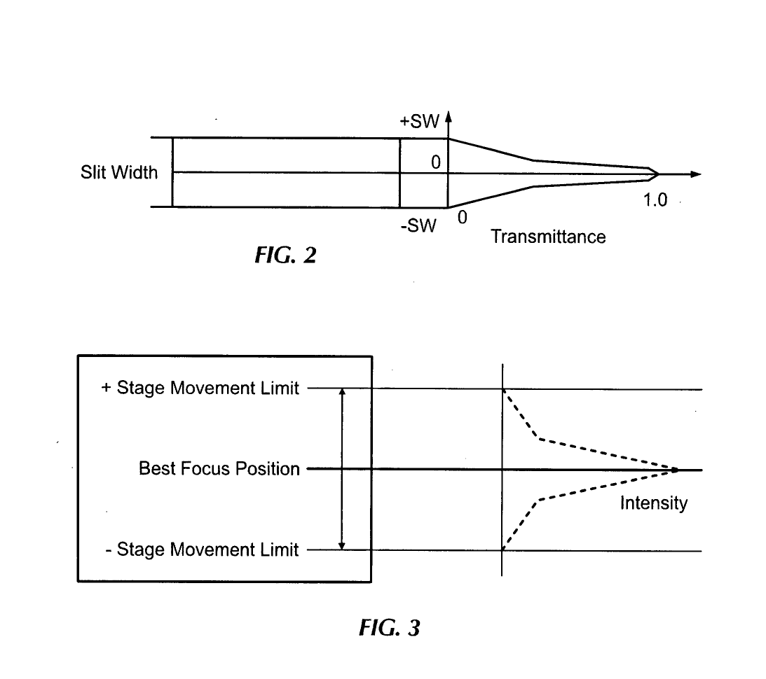

By weighting the radiation energy more heavily at the best (optimal) focus position, rather than allowing an even energy distribution across the entire exposure slit, the exposure latitude is preserved while maintaining a large DOF. This can be accomplished, for example, by placing a filter adjacent the exposure slit. FIG. 2 shows the effect of placing a filter in accordance with a preferred embodiment of the present invention adjacent the slit. The transmittance at the center line, shown as the x-axis, is at a maximum. The transmittance decreases as the radiation proceeds further away from the center line in either direction toward the edges. In the particular example in FIG. 2, a sharp drop in transmittance is shown close to the center before tapering off at a slower rate as the radiation approaches the edges.

FIG. 3 shows a similar diagram in terms of the imaging planes of the substrate. The substrate is aligned such that the radiation directed through the center of the exposure slit contacts the substrate at the best (optimal) focus position of the lens. In other words, as the substrate proceeds through the scan, the portion of the substrate directly beneath the center of the slit at any time is at the best (optimal) focus position. With the filter in place, the intensity of the radiation contacting the substrate at that point will be at a maximum, as shown in FIG. 3. Again in this example, the intensity drops sharply around the center and tapers off to a shallower slope as the radiation approaches the edges. The edges correspond to the incline of the substrate stage, as will be described below. The type of filter and the energy distribution of the filter may be adjusted to suit individual manufacturing specifications. However, the filter allowing maximum energy at the best (optimal) focus position and minimal energy at the defocus positions is suitable for most applications. A filter weighting energy at 20%-60%-20%, as will be explained below, shows the best performance.

The quality of the pattern transfer to the photoresist also depends on selecting an appropriate focus range. The focus range is the difference in height between the lowest portion of the substrate exposed under the slit and the highest portion of the substrate exposed under the slit. The focus range can be found mathematically by the following equation:

Focus Range=Slit width*tan [Tilt Amount from Stage/100000]

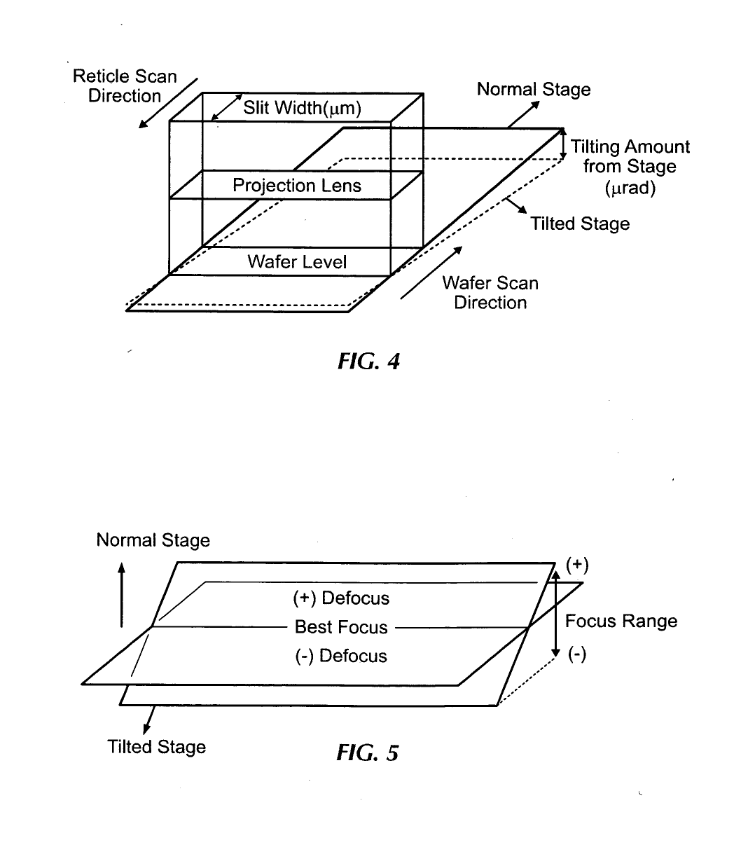

FIG. 4 shows the assembly for calculating the focus range. The “Normal Stage” is shown by a solid line at an angle generally parallel to the slit. The “Tilted Stage” is represented by the dashed line, and the angle between the two shown in FIG. 4 is the angle utilized in the above equation. The angle will typically be on the order of μradians. Similarly, the slit width, shown above the projection lens, is typically on the order of μm. As a result, the focus range is also often on the order of μm.

FIG. 5 shows an example of slit intensity formation on the wafer. The brightest area is formed at the best (optimal) focus line. The intensity dissipates toward the defocus positions on the tilted wafer. The defocus is the distance on the optical axis between the best (optimal) focus position and the position of the wafer. Therefore the focus range can be defined also as the distance between the maximum positive defocus of the tilted stage exposed to the slit and the maximum negative defocus of the tilted stage exposed to the slit.

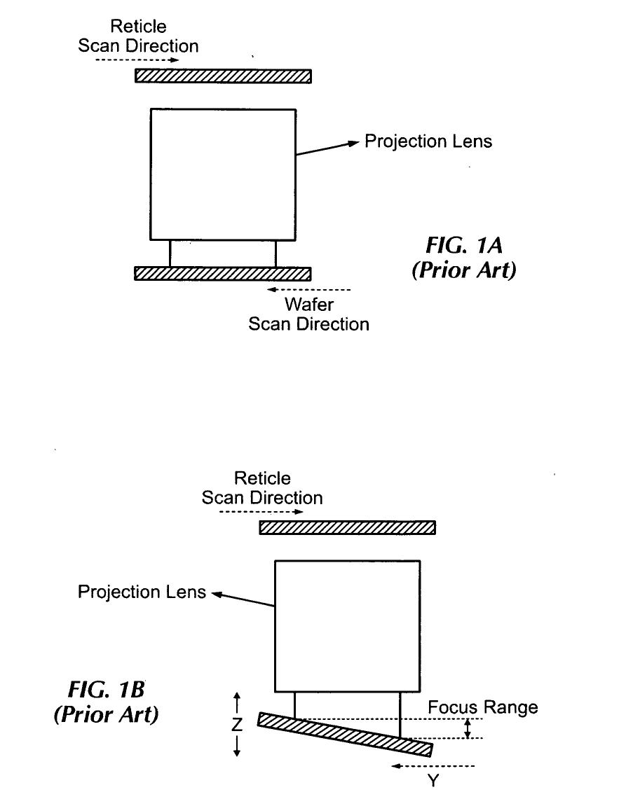

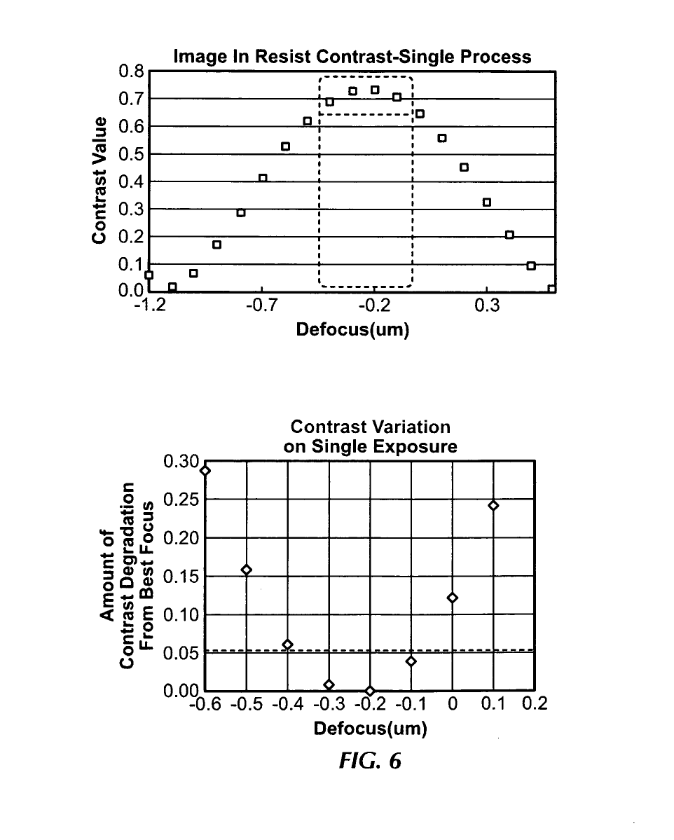

To demonstrate the benefits of embodiments of the present invention, data was collected for single, double, and triple imaging with even energy distribution, and triple imaging with varied energy distribution. The data was collected by performing scans using the configuration in FIG. 1A. FIG. 6 shows the results of a single image scan. The image was placed at various defocus positions in increments of 0.1 μm. The first plot measures the contrast value of the image at each defocus point. While the process shows good contrast of near or above 70% for several points, the slope of the curve is steep in both directions. In less than 0.5 μm in either direction, the contrast can deteriorate to less than 40%. The second plot shows the contrast degradation as a function of defocus. In just 0.3 μm, the contrast can degrade by nearly 30%.

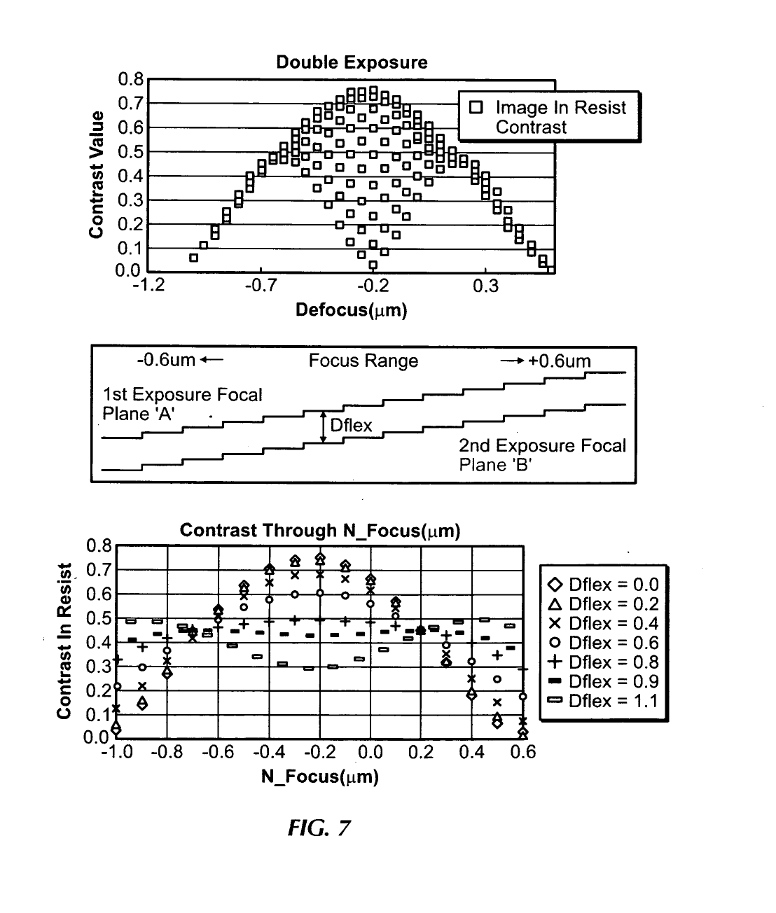

FIG. 7 shows the results of double imaging with even energy weighting. The image plane separation is labeled as the D_{flex} value. The first plot again shows good contrast at the peak, but the curve slopes on both sides are slightly flatter. The third plot shows the contrast results for individual D_{flex} values at N_Focus (average focus—similar to defocus) positions. Where D_{flex} is 0.0 or 0.2 μm, the image planes basically coincide, and the results are similar to a single image. As D_{flex} increases, the peak of the curve recedes, but the curve itself is flatter, showing much less variation with change in the N_Focus. Of course, at some point the D_{flex} becomes too large and the benefits are lost, as shown by D_{flex} at 1.1 μm.

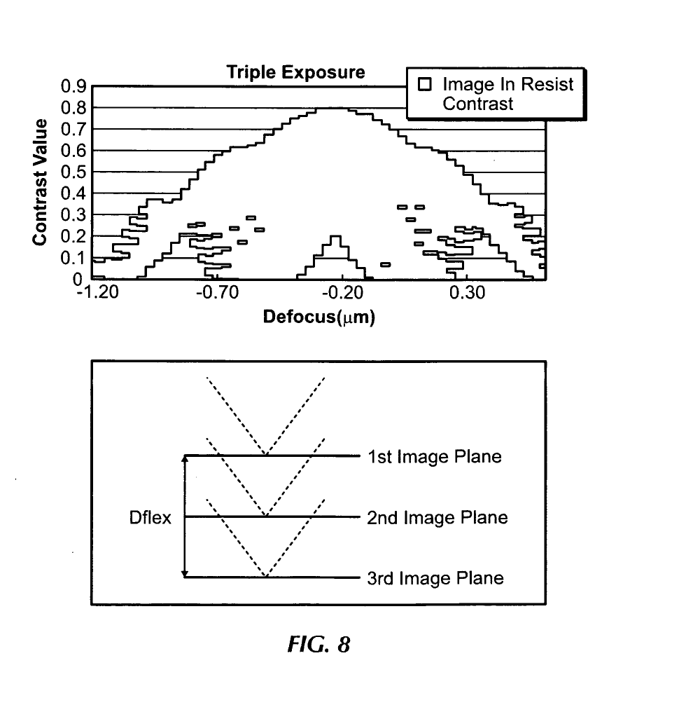

FIG. 8 shows the results of triple imaging. Here, D_{flex} is the distance between the top and bottom image planes, with the second image plane sandwiched in between. The plot demonstrates that with three images, the curve has flattened and the contrast level is above 50% for a much wider range. The more images that are added, the more level the contrast curve becomes.

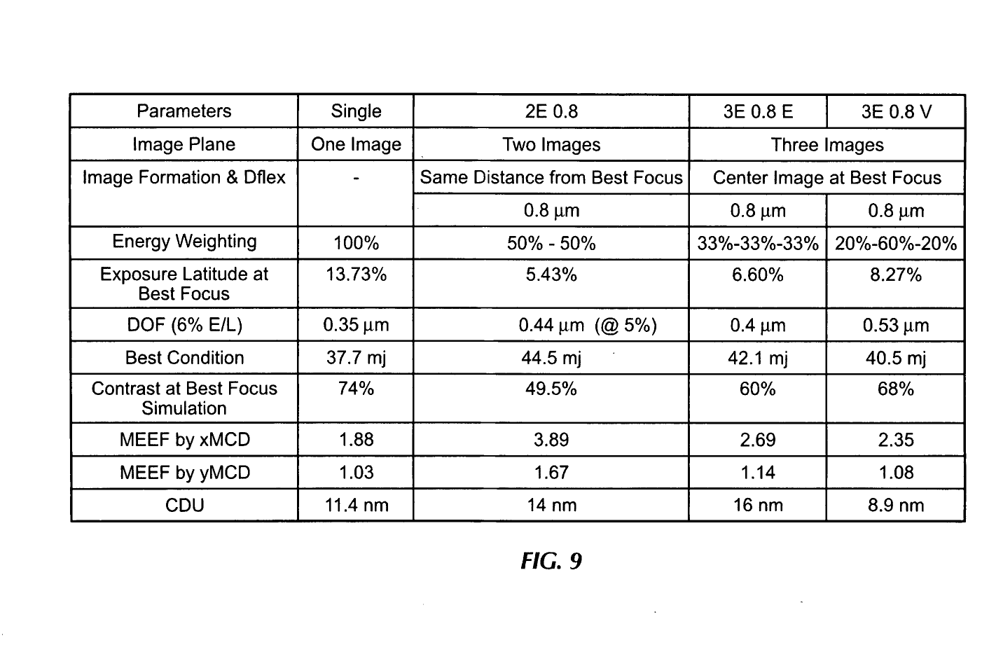

FIG. 9 now compares the three previous examples, centered at the best (optimal) focus position, with a triple image process with varied energy weighting. The D_{flex} for all multiple image techniques was set at 0.8 μm. The chart of FIG. 9 shows that the energy is weighted 20%-60%-20% for the varied run. The 60% is on the best (optimal) focus image plane. While the single image attains a 13.73% exposure latitude at the best (optimal) focus, as compared to the 8.27% for the varied triple image, the DOF at which the exposure latitude falls below 6% is much higher for the varied triple image (0.53 μm). The critical dimension uniformity is also at its best for the varied triple image (8.9 nm) as compared to 11.4 nm for the single image.

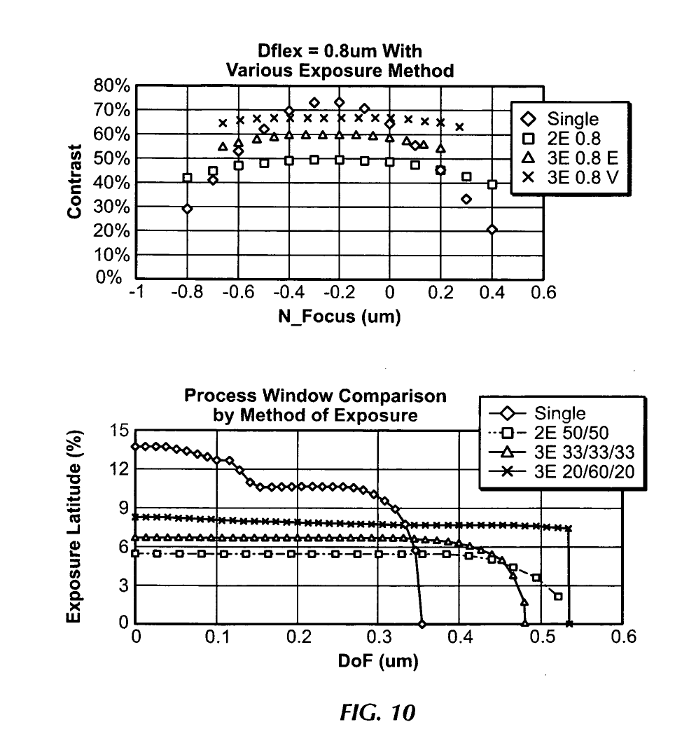

FIG. 10 shows plots of some of the results charted in FIG. 9. The first plot shows the contrast against the N_Focus. As described earlier, the single image attained the highest peak contrast. However, the varied triple image curve is much flatter, with a variation of less than 10% over a 1 μm range. It is also higher than both the evenly weighted double and triple images. The second plot shows the exposure latitude as a function of DOF. The single image has the highest peak, as mentioned above, but at about 0.3 μm, the exposure latitude plummets dramatically. The varied triple image is much more consistent and shows little variation for a wide DOF range.

By tilting the substrate stage, an infinite number of image planes is produced. As the results above clearly show, distributing the energy closer to the best (optimal) focus position for multiple image planes improves both contrast and exposure latitude.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. An apparatus for transferring a pattern to a substrate, the apparatus comprising:
(a) a radiation source directing radiation along a radiation path;
(b) an exposure slit positioned along the radiation path for directing the radiation at the substrate, the exposure slit having a center portion and edge portions;
(c) a lens positioned along the radiation path and having an optimal focus position;
(d) a support stage for supporting and moving the substrate relative to the radiation path along a substrate path, the support stage being inclined at a stage angle relative to the radiation path, such that radiation passing through the center portion of the exposure slit contacts the substrate at the optimal focus position of the lens; and
(e) a filter positioned along the radiation path and adjacent the exposure slit, the filter configured to transmit more of the radiation at the center portion of the exposure slit relative to radiation transmitted at the edge portions of the exposure slit.

2. The apparatus of claim 1, further comprising:
(f) a reticle containing the pattern to be transferred, the reticle being movable relative to the radiation path along a reticle path which is substantially perpendicular to the radiation path.

3. The apparatus of claim 2, wherein the substrate is movable generally in a first direction and the reticle is movable in a second direction, the first and second directions being opposite of each other.

4. The apparatus of claim 1, wherein the exposure slit has a slit width and the filter has a filter width, the slit width and filter width being nearly identical.

5. A method of transferring a pattern to a substrate using radiation directed along a radiation path, the radiation passing through an exposure slit having a center portion and edge portions, the radiation further passing through a lens having an optimal focus position, the method comprising:
(a) orienting the substrate at a non-normal angle relative to the radiation path;
(b) moving the substrate relative to the radiation path along a substrate path such that the radiation passing through the center portion of the exposure slit contacts the substrate at the optimal focus position of the lens; and
(c) distributing the radiation such that more of the radiation is transmitted from the center portion of the exposure slit relative to the radiation transmitted from the edge portions of the exposure slit.

6. The method of claim 5 further comprising:
(d) moving a reticle relative to the radiation path along a reticle path substantially perpendicular to the radiation path, the reticle containing the pattern to be transferred to the substrate.

7. The method of claim 6 wherein step (d) further comprises moving the reticle in a direction generally opposite to the direction of movement of the substrate.

8. The method of claim 6 wherein the lens has a reduction factor and step (d) further comprises moving the substrate at a first rate, and moving the reticle at a second rate which is less than the first rate by about the reduction factor.
